(19) United States
(12) Patent Application Publication
(10) Pub. No.: US 2016/0337378 A1
(43) Pub. Date: Nov. 17, 2016

(54) METHOD AND APPARATUS FOR DETECTING SECURITY OF ONLINE SHOPPING ENVIRONMENT

(71) Applicant: BEIJING QIHOO TECHNOLOGY COMPANY LIMITED, Beijing (CN)

(72) Inventors: Renguo WAN, Beijing (CN); Peng XIAO, Beijing (CN); Qi LIU, Beijing (CN)

(21) Appl. No.: 15/107,948

(22) PCT Filed: Sep. 28, 2014
(86) PCT No.: PCT/CN2014/087712

§ 371 Date: Jun. 24, 2016

(30) Foreign Application Priority Data
Dec. 26, 2013 (CN) 201310731435.9

(51) Int. Cl. H04L 29/06; G06Q 20/38

(52) U.S. Cl. CPC H04L 63/14; H04L 63/101; H04L 63/20; G06Q 20/382; H04L 2463/102

(57) ABSTRACT

Embodiments of the invention disclose a method and apparatus for detecting security of an online shopping environment. The method comprises: triggering a corresponding monitoring mode according to that a user operates a website via a terminal browser, wherein the monitoring mode comprises an online shopping monitoring mode or a payment monitoring mode; and sending danger prompt information to the terminal if in the monitoring mode it is monitored that the website is an unknown website and it is determined that the unknown website is a dangerous website according to a preset security policy, wherein the security policy is a preset policy for guaranteeing security of an online shopping environment. The present invention can ensure the security of the online shopping environment of the user.

### FIELD OF THE INVENTION

The application relates to the field of network security technologies, and in particular, to a method and apparatus for detecting security of an online shopping environment.

### BACKGROUND OF THE INVENTION

With the extension of network applications, a network user can pay various fees online. The most common application is such that a user conducts online transfer payment via a network bank which is opened in advance when he logs in an online shopping mall to purchase an item. During the payment via the network bank, the user needs to input a bank card account number and a preset password, and therefore, it is of great importance to protect the security of the online payment.

However, in a practical application, a malicious third party will usually steal a network bank account number and a password of a user via a Trojan. For example, when a user clicks a payment button on a webpage, the payment page which he enters may be a malicious webpage which is preset by a malicious third party and similar to a normal payment webpage. Once the user enters a username and a password on the malicious webpage, this results in that the network bank information of the user will be stolen. From this, it can be seen that in an existing online shopping procedure, the network bank information of a user will be easily stolen and used, which results in that the security of online shopping is not high, and will easily cause a loss to the user.

To improve the security of online shopping, in the prior art, what is done is to send the URL of a shopping website which a user is visiting currently to a monitoring server for examination, to determine whether the URL of the shopping website is the URL of a phishing website pre-gathered by the monitoring server. However, since there is a massive amount of information on the internet, new phishing websites will be produced everyday. Moreover, due to the timeliness problem, the monitoring server can not update a collection of URLs of phishing websites that are pre-gathered in time, and therefore, there are problems that a newly produced phishing website can not be detected in time and the probability of missed detection is relatively high, which reduces the security of an online shopping environment.

### SUMMARY OF THE INVENTION

To solve the above technical problems, embodiments of the application provide a method and apparatus for detecting security of an online shopping environment, which can detect the security of an online shopping environment of a terminal in real time when a user conducts online shopping via the terminal, ensure the security of online shopping for the user and avoid causing a loss to the user.

The embodiments of the application disclose the following technical solutions.

A method for detecting security of an online shopping environment comprises: triggering a corresponding monitoring mode according to that a user operates a website via a terminal browser, wherein the monitoring mode comprises an online shopping monitoring mode or a payment monitoring mode;

sending danger prompt information to the terminal if in the monitoring mode it is monitored that the website is an unknown website and it is determined that the unknown website is a dangerous website according to a preset security policy, wherein the security policy is a preset policy for guaranteeing security of an online shopping environment;

wherein determining that the unknown website is a dangerous website according to a preset security policy comprises at least one of the following:

determining that the unknown website is a dangerous website if it is determined according to a domain name of the unknown website that the domain name is a second level domain name and the second level domain name is comprised in a domain name blacklist;

determining that the unknown website is a dangerous website according to an IP address of the unknown website if the IP address is comprised in an IP address blacklist;

according to an uniform resource locator URL of the unknown website, calculating a hash value of the URL, and determining that the unknown website is a dangerous website if the calculated hash value is comprised in a hash value blacklist; and

according to a monitoring log saved in the terminal, and numbers of white-list tags, blacklist tags and unknown tags of websites operated by the terminal recorded in a preset period of time, determining that the unknown website is a dangerous website if the number of the blacklist tags is greater than a preset threshold; or determining that the unknown website is a dangerous website if the number of the unknown tags is greater than a preset threshold and the number of the white-list tags is less than or equal to the number of the blacklist tags.

Optionally, the triggering a corresponding monitoring mode according to that a user operates a website via a terminal browser comprises:

obtaining a keyword comprised in the domain name of the website, and determining that the website is a shopping website and opening the online shopping monitoring mode if the keyword matches a preset online shopping feature word; or determining that the website is a payment website and opening the payment monitoring mode if the keyword matches a preset payment feature word.

Optionally, after the triggering a corresponding monitoring mode according to that a user operates a website via a terminal browser, there is comprised:

saving an operation record of the user operating the website via the terminal browser in the monitoring log, wherein the operation record comprises an identification and operation time of the website.

Optionally, after the sending danger prompt information to the terminal in the monitoring mode if it is monitored that the website is an unknown website and it is determined that the unknown website is a dangerous website according to a preset security policy, there is comprised:

saving n identification and a corresponding unknown tag of the website and the danger prompt information in the monitoring log, wherein the identification of the website comprises a domain name or URL of the website.

Optionally, the method further comprises:

receiving a compensation request triggered by the user via the terminal browser, wherein the compensation request comprises the identification of an illegal website;

querying the monitoring log saved in the terminal according to the identification of the illegal website comprised in the compensation request;

determining that the interception fails and sending to the terminal a message that the compensation request is successful, if it is determined that the monitoring log comprises the identification of the illegal website and does not comprise the danger prompt information corresponding to the identification of the illegal website; and

adding the identification of the illegal website into a website blacklist library.

Optionally, after the triggering a corresponding monitoring mode according to that a user operates a website via a terminal browser, there is comprised:

if an unknown executable file is monitored in the monitoring mode, intercepting the unknown executable file and sending danger prompt information to the terminal.

An apparatus for detecting security of an online shopping environment comprises:

a monitoring module configured to trigger a corresponding monitoring mode according to that a user operates a website via a terminal browser, wherein the monitoring mode comprises an online shopping monitoring mode or a payment monitoring mode;

a determination module configured to, in the monitoring mode, determine whether the website is an unknown website and determine whether the unknown website is a dangerous website according to a preset security policy;

a sending module configured to send danger prompt information to the terminal when the determination module determines that the website is an unknown website and determines that the unknown website is a dangerous website according to the preset security policy, wherein the security policy is a preset policy for guaranteeing security of an online shopping environment;

wherein the determination module is particularly configured to:

determine that the unknown website is a dangerous website if it is determined according to a domain name of the unknown website that the domain name is a second level domain name and the second level domain name is comprised in a domain name blacklist; and/or

determine that the unknown website is a dangerous website according to an IP address of the unknown website if the IP address is comprised in an IP address blacklist; and/or

according to an uniform resource locator URL of the unknown website, calculate a hash value of the URL, and determine that the unknown website is a dangerous website if the calculated hash value is comprised in a hash value blacklist; and/or

according to a monitoring log saved in the terminal, and numbers of white-list tags, blacklist tags and unknown tags of websites operated by the terminal recorded in a preset period of time, determine that the unknown website is a dangerous website if the number of the blacklist tags is greater than a preset threshold; or determine that the unknown website is a dangerous website if the number of the unknown tags is greater than a preset threshold and the number of the white-list tags is less than or equal to the number of the blacklist tags.

Optionally, the monitoring module is particularly configured to

obtain a keyword comprised in the domain name of the website, and determine that the website is a shopping website and open the online shopping monitoring mode if the keyword matches a preset online shopping feature word; or determine that the website is a payment website and open the payment monitoring mode if the keyword matches a preset payment feature word.

Optionally, the apparatus further comprises:

a saving module configured to save an operation record of a user operating a website via a terminal browser in the monitoring log, wherein the operation record comprises the identification and the operation time of the website.

Optionally, the saving module is further configured to save an identification and a corresponding unknown tag of the website and the danger prompt information in the monitoring log, wherein the identification of the website comprises a domain name or URL of the website.

Optionally, the apparatus further comprises:

a reception module configured to receive a compensation request triggered by the user via the terminal browser, wherein the compensation request comprises the identification of an illegal website;

a query module configured to query the monitoring log saved by the saving module according to the identification of the illegal website comprised in the compensation request received by the reception module;

wherein the determination module is further configured to determine that the interception fails if it is determined that the monitoring log comprises the identification of the illegal website and does not comprise the danger prompt information corresponding to the identification of the illegal website;

the sending module is further configured to send to the terminal a message that the compensation request is successful when the determination module determines that the interception fails; and

the saving module is further configured to add the identification of the illegal website into a website blacklist library.

A computer program comprises a computer readable code which causes a computing device to perform the method for detecting security of an online shopping environment as described above, when said computer readable code is running on the computing device.

A computer readable medium stores therein the computer program as described above.

The beneficial effects of the invention lie in that:

In the embodiment of the invention, a monitoring mode is triggered when it is monitored that a user operates a website via a terminal browser; and danger prompt information is sent to the terminal if it is determined that the website which is visited currently by the terminal is unknown, and it is determined that the currently visited website is dangerous according to a preset security policy. According to the embodiment of the invention, it can be achieved that when it is detected that the website visited by the user via the terminal browser is an unknown website, a monitoring server determines whether the currently visited website is dangerous according to a preset security policy, and when it is determined to be dangerous, sends danger prompt information to the terminal, which reduces the probability of missed detection. Therefore, according to the embodiment of the invention, the security of the online shopping environment of the user can be ensured.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

In order to more clearly illustrate the technical solutions in embodiments of the application or in the prior art, the appended drawings that need to be used in the descriptions of the embodiments or the prior art will be introduced briefly in the following. Obviously, for those of ordinary skills in the art, other drawings may also be obtained according to these drawings under the premise of not paying out creative work.

FIG. 1 is a flow diagram of a method for detecting security of an online shopping environment provided by an embodiment of the invention;

FIG. 2 is a flow diagram of online shopping pre-compensation provided by another embodiment of the invention;

FIG. 3 is a schematic diagram of a show window of danger prompt information of an embodiment of the invention;

FIG. 4 is a structural diagram of an apparatus for detecting security of an online shopping environment provided by an embodiment of the invention;

FIG. 5 shows schematically a block diagram of a computing device for performing a method for detecting security of an online shopping environment according to the invention; and

FIG. 6 shows schematically a storage unit for retaining or carrying a program code implementing a method for detecting security of an online shopping environment according to the invention.

### DETAILED DESCRIPTION OF THE INVENTION

To make the skilled in the art understand the technical solutions in embodiments of the invention more clearly, and make the above objectives, features and advantages of the embodiments of the invention more apparent and understandable, in the following, the technical solutions in embodiments of the invention will be further described in detail in connection with the drawings.

Embodiments of the invention can be applied in a computer system/server, which can be operated together with a multitude of other general- or special-purpose computing system environments or configurations. Examples of well known computing systems, environments and/or configurations suitable for use with a computer system/server comprise, but not limited to, a personal computer system, a server computer system, a thin client, a hand held or laptop device, a microprocessor-based system, a set-top box, a programmable consumer electronic product, a network personal computer, a small computer system, a large computer system and a distributed cloud computing technology environment comprising the any above system, etc.

A computer system/server can be described in the general context of a computer system executable instruction (such as a program module) executed by a computer system. In general, the program module can comprise a routine, a program, target program, component, logic, data structure, etc., which performs a specific task or implements a specific abstract data type. The computer system/server can be embodied in a distributed cloud computing environment, and in the distributed cloud computing environment, a task is performed by a remote processing device linked by a communication network. In the distributed cloud computing environment, the program module can be located on a local or remote computing system storage medium comprising a storage device.

It needs to be noted that the embodiment of the invention can implement detection of the security of an online shopping environment by a monitoring application program (e.g., the 360 website safeguard) installed at a terminal side.

In the embodiment of the invention a list of blacklist websites and a list of white-list websites are preset, and in the list of white-list websites are saved network addresses of secure, credible shopping websites and payment websites or other information of the websites. Therein, the secure, credible shopping websites and payment websites can be websites authenticated in advance, and can be gathered by a monitoring server according to server information, e.g., the URL, HOST, the Internet Protocol (IP), of a webpage, and related information, e.g., the Internet Content Provider (ICP) recorded information (e.g., the name of the organizer, the nature of the organizer, the business scope, the audit time, etc.), the WHOIS (a transfer protocol) information (e.g., the registrars, domain name server, related websites, domain name system server, domain name state, update time, creation time, expiration time, the weight of the domain name in other search engine, and the amount of collected webpages, etc.), of the domain name of the webpage, of which the particular procedure will not be discussed here in detail by the embodiment of the invention any more.

In the list of blacklist websites are saved network addresses of dangerous shopping websites and payment websites or other information of the websites, wherein the dangerous shopping websites and payment websites comprise a phishing website, a malicious link, a website linked to a Trojan or virus, which will not be limited by the embodiment of the invention.

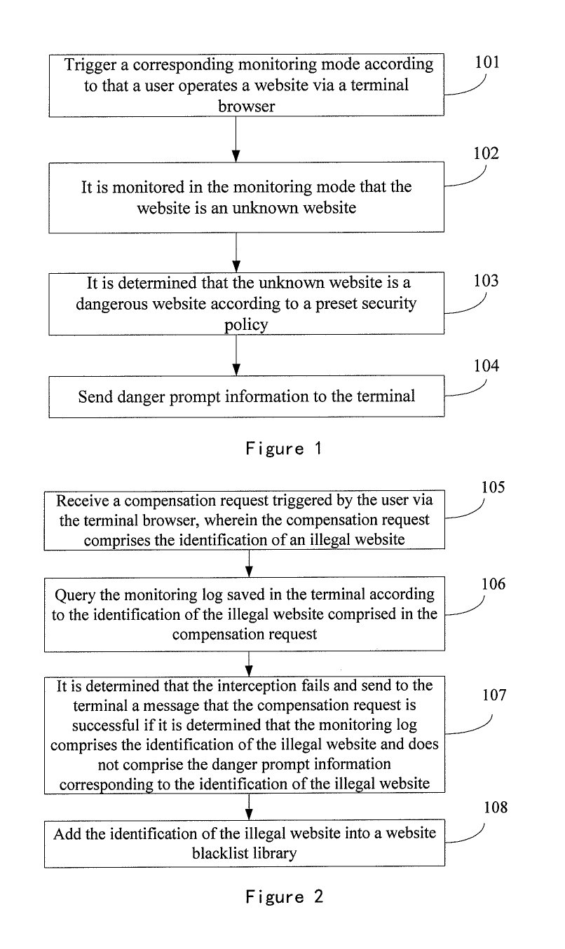

FIG. 1 is a flow diagram of a method for detecting security of an online shopping environment provided by an embodiment of the invention. As shown in FIG. 1, the flow comprises at least step 101 to step 104.

At 101, a corresponding monitoring mode is triggered according to that a user operates a website via a terminal browser, wherein the monitoring mode comprises an online shopping monitoring mode or a payment monitoring mode.

In an optional embodiment of the invention, the step 101 comprises:

obtaining a keyword comprised in the domain name of the website, and determining that the website is a shopping website and opening the online shopping monitoring mode if the keyword matches a preset online shopping feature word; or determining that the website is a payment website and opening the payment monitoring mode if the keyword matches a preset payment feature word.

When specifically implementing, in the embodiment, according to a collection of shopping websites that are pre-gathered, the domain name of each shopping website is analyzed to extract the online shopping feature word of each shopping website, and a collection of online shopping feature words is obtained. For example, the domain name of the Taobao marketplace is www.taobao.com, and taobao is set to be the online shopping feature word of the Taobao marketplace and added into the collection of online shopping feature words. When the domain name of a current website logged in by a user via a terminal browser is b2b.taobao.cn, since the keyword taobao comprised in the domain name matches an online shopping feature word taobao comprised in the collection of online shopping feature words, it can be determined that the website currently logged in by the user is a shopping website, and the opening of the online shopping monitoring mode is triggered. Likewise, according to a collection of payment websites that are pre-gathered, the embodiment can also analyze the domain name of each payment website, then extract the payment feature word of each payment website, and obtain a collection of payment feature words. For example, the domain name of the China Merchants Bank is www.cmbchina.com, and cmbchina is set to be the payment feature word of the website of the China Merchants Bank, and added into the preset collection of payment feature words. When the domain name of a website which a user logs in currently is b2b.cmbchina.com, since the keyword cmbchina comprised in the domain name matches a payment feature word cmbchina comprised in the collection of payment feature words, it can be determined that the website currently logged in by the user is a payment website, and the opening of the payment monitoring mode is triggered.

In an optional embodiment of the invention, after a user operates a website via a terminal browser to trigger a corresponding monitoring mode, there is further comprised:

saving the operation record of the user operating the website via the terminal browser in the monitoring log, wherein the operation record comprises, but is not limited to, the identification and the operation time of the website which is operated by the user via the terminal browser. Therein, the identification of the website comprises, but is limited to, the domain name or the uniform/universal resource locator (URL) of the website, and the operation time comprises the login time and the payment time. Further, it may also be possible to save information of an item bought by the user in the website into the operation record.

To avoid being deceived by an illegal website (e.g., a phishing website, a Trojan, a plugged Trojan or a malicious program) and guarantee the security of an online shopping environment of a user, in an optional embodiment of the invention, after a user operates a website via a terminal browser to trigger a corresponding monitoring mode, in the monitoring mode, since during the visit of a shopping website or a payment website, some shopping websites or payment websites may be phishing websites which carry a virus such as a Trojan, a plugged Trojan or etc., and a malicious file may be received which is transferred by a third party to the user, a program executed in the procedure of the user visiting the shopping website or payment website can be placed in a secure environment for running.

In an embodiment of the invention, a list of blacklist websites and a list of white-list websites are preset. Suppose that the list of blacklist websites comprises the URL of each blacklist websites. When the URL of the website currently visited by the user is comprised in the list of blacklist websites, it can be determined that the website currently visited by the user is a blacklist website, and the blacklist website can be intercepted directly in the monitoring mode of the embodiment.

Suppose that the list of white-list websites comprises the URL of each white-list website. When the URL of the website currently visited by the user is comprised in the list of white-list websites, it can be determined that the website currently visited by the user is a white-list website, and the user can be allowed to visit the white-list website in the monitoring mode of the embodiment.

At 102, it is monitored in the monitoring mode that the website is an unknown website.

In practical applications, there is a vast amount of information on the internet, new phishing websites will be produced everyday, and due to the timeliness problem, the list of blacklist websites that are pre-gathered can not be updated in time. To reduce the probability of missed detection and improve the security of the online shopping environment, in an embodiment of the invention, it is determined that the website currently visited by the user is an unknown website when the URL of the website currently visited by the user is neither comprised in the list of blacklist websites, nor comprised in the list of white-list websites. Afterwards, it is further detected whether the unknown website is a dangerous website according to methods of subsequent step 103 and step 104.

At 103, it is determined that the unknown website is a dangerous website according to a preset security policy, wherein the security policy is a preset policy for guaranteeing the security of an online shopping environment.

In an optional embodiment of the invention, when implemented particularly, the step 103 comprises:

determining that the unknown website is a dangerous website if it is determined according to the domain name of the unknown website that the domain name is a second level domain name and the second level domain name is comprised in a domain name blacklist. For example, after it is monitored that the website currently visited by the user is an unknown website, the domain name of the unknown website is obtained, and according to URLs of dangerous websites comprised in the list of blacklist websites, they are queried one by one to obtain the domain name corresponding to each dangerous website. By conducting statistics on domain names of known dangerous websites, it can be found that the probability of danger of a second level domain name is relatively high, and the second level domain name is taken as a dangerous domain name and saved into a domain name blacklist library. If the currently visited website is an unknown website, the domain name of the unknown website can be further determined according to the URL of the unknown website, and if the domain name of the unknown website matches a dangerous domain name in the domain name blacklist library, it can be determined that the probability of danger of the unknown website is relatively high, that is, the unknown website is a dangerous website.

In an optional embodiment of the invention, when implemented particularly, the step 103 further comprises:

determining that the unknown website is a dangerous website according to the IP address of the unknown website if the IP address is comprised in an IP address blacklist. For example, in a practical application, according to URLs of dangerous websites comprised in the list of blacklist websites, it is possible to further query them one by one via a domain name server to obtain the IP address of the website server corresponding to each dangerous website. It is found by statistics that if the number of dangerous websites corresponding to the IP address exceeds a preset number threshold (for example, the threshold is 1000), or the ratio of the number of dangerous websites corresponding to the IP address to the number of all the websites corresponding to the IP address exceeds a preset ratio threshold (for example, 50%), the IP address can be determined to be a dangerous IP address, and the dangerous IP address is saved into an IP address blacklist library. Therefore, when the currently visited website is an unknown website, the IP address corresponding to the unknown website can be further obtained via a domain name system (DNS for short hereinafter) server, and if the IP address matches a dangerous IP address in the IP address blacklist library, it can be determined that the probability of danger of the unknown website is relatively large.

It needs to be noted that, in view of the characteristic that the degree of danger of a foreign (outside the applicant country) IP address is higher than that of a domestic (inside the applicant country) IP address, in order to cause the probability of danger prompt of a foreign IP address to be higher than that of a domestic IP address, the number threshold and ratio threshold set above can be different according to whether the IP address is a foreign IP address. For example, if it is a foreign IP address, the ratio threshold is set to be 30%, and if it is a domestic IP address, the ratio threshold is set to be 60%. The specific number which is set for the threshold will not be defined by the invention.

In an optional embodiment of the invention, when implemented particularly, the step 103 further comprises:

according to the uniform resource locator URL of the unknown website, calculating the hash value of the URL, and determining that the unknown website is a dangerous website if the calculated hash value is comprised in a hash value blacklist. For example, in a practical application, according to URLs of dangerous websites comprised in the list of blacklist websites, the refer chain address of the URL of each dangerous website is detected, the hash value of the refer chain address of each dangerous website is calculated, and a hash value blacklist is obtained. Therefore, when the currently visited website is an unknown website, the refer chain address of the URL of the unknown website is obtained, the hash value of the refer chain address of the unknown website is calculated, and it is determined that the probability of danger of the unknown website is relatively large if the hash value of the refer chain address of the unknown website is in the hash value blacklist.

In an optional embodiment of the invention, when implemented particularly, the step 103 further comprises:

according to a monitoring log saved in the terminal, and the numbers of white-list tags, blacklist tags and unknown tags of websites operated by the terminal recorded in a preset period of time, determining that the unknown website is a dangerous website if the number of the blacklist tags is greater than a preset threshold; or determining that the unknown website is a dangerous website if the number of the unknown tags is greater than a preset threshold and the number of the white-list tags is less than or equal to the number of the blacklist tags.

For example, table 1 is a structure of the monitoring log applied in an embodiment of the invention, as shown in table 1:

| Monitoring | | | |
|---|---|---|---|
| mode | White-list tag | Blacklist tag | Unknown tag |
| Online | List of URLs of | List of URLs of | List of URLs of |
| shopping | white-list | blacklist websites | unknown websites |
| monitoring | websites | | |
| mode | | | |
| Payment | List of URLs of | List of URLs of | List of URLs of |
| monitoring | white-list | blacklist websites | unknown websites |
| mode | websites | | |

wherein in the online shopping monitoring mode, in the list of URLs of white-list websites can be saved URLs and corresponding white-list tags of shopping websites which are confirmed to be secure in a preset period of time, in the list of URLs of blacklist websites can be saved URLs and corresponding blacklist tags of shopping websites which are confirmed to be dangerous in the preset period of time, and in the list of unknown URLs can be saved URLs and corresponding unknown tags of shopping websites which are confirmed to be unknown in the preset period of time;

wherein in the payment monitoring mode, in the list of URLs of white-list websites can be saved URLs and corresponding white-list tags of payment websites which are confirmed to be secure in a preset period of time, in the list of URLs of blacklist websites can be saved URLs and corresponding blacklist tags of payment websites which are confirmed to be dangerous in the preset period of time, and in the list of URLs of unknown websites can be saved URLs and corresponding unknown tags of payment websites which are confirmed to be unknown in the preset period of time,

the numbers of white-list tags, blacklist tags and unknown tags of websites operated by the terminal recorded by a monitoring log in the preset period of time are counted, and it is determined that the unknown website is a dangerous website if the number of the blacklist tags is greater than a preset threshold; or it is determined that the probability of danger of the unknown website is relatively large if the number of the unknown tags is greater than a preset threshold and the number of the white-list tags is less than or equal to the number of the blacklist tags.

It needs to be noted that the specific implementation when the embodiment of the invention determines that the unknown website is a dangerous website according to a preset security policy is not limited to the above illustrated security policies. In order to further improve the rate of recognition with respect to whether the unknown website is a dangerous website, an embodiment of the invention can further combine the above security policies together for consideration.

For example, when the IP address corresponding to the unknown website matches a dangerous IP address in the IP address blacklist library, it can be further judged whether the unknown website is a second level domain name and whether the second level domain name is in the domain name blacklist library, and if yes, it is determined that the unknown website is a dangerous website.

As another example, when the IP address corresponding to the unknown website matches a dangerous IP address in the IP address blacklist library, it is possible to further calculate the hash value of the refer chain address of the unknown website, and judge whether the hash value is in the hash value blacklist, and if yes, determine that the unknown website is a dangerous website.

As another example, suppose that the website currently visited by the user is an unknown website, and the numbers of white-list tags, blacklist tags and unknown tags of websites operated by the terminal recorded by the monitoring log in the preset period of time are counted. If the number of blacklist tags is greater than a preset threshold, or if the number of unknown tags is greater than a preset threshold, and the number of white-list tags is less than or equal to the number of blacklist tags, it can be further judged whether the IP address corresponding to the unknown website matches a dangerous IP address in the IP address blacklist library, and if yes, it is determined that the unknown website is a dangerous website; or it can be further judged whether the unknown website is a second level domain name and whether the second level domain name is in the domain name blacklist library, and if yes, it is determined that the unknown website is a dangerous website; or it is possible to further calculate the hash value of the refer chain address of the unknown website and judge whether the hash value is in the hash value blacklist, and if yes, it is determined that the unknown website is a dangerous website.

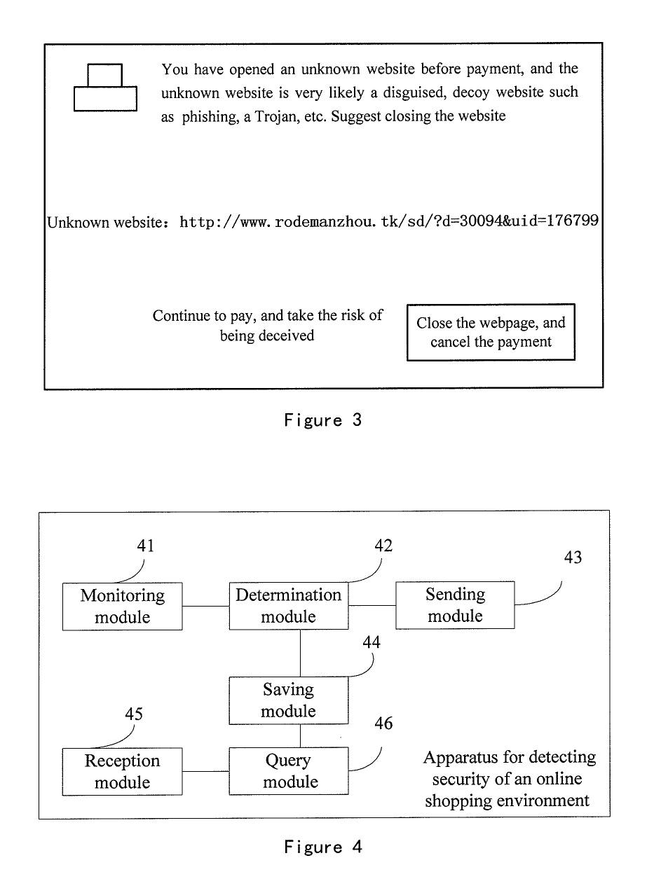

At 104, danger prompt information is sent to the terminal, wherein the danger prompt information can be shown via a popup window of the terminal browser. FIG. 3 is a schematic diagram of a show window of danger prompt information of an embodiment of the invention. As shown in FIG. 3, the show window can prompt that the URL of the website currently visited by the terminal is an unknown website, can prompt information that the current online shopping environment of the terminal is dangerous, for example, “You have opened an unknown website before payment, and the unknown website is very likely a disguised, decoy website such phishing, a Trojan, etc.”, or also can provide and display a corresponding suggestion, for example, “Suggest closing the website”, or the like.

In an optional embodiment of the invention, after the step 104, there is further comprised:

saving the identification and a corresponding unknown tag of the unknown website and the danger prompt information in the monitoring log, wherein the identification of the unknown website comprises, but is not limited to, the domain name or URL of the unknown website.

To improve the security defense level of online shopping or online payment by the user, and guarantee the security of the online shopping environment, when opening the monitoring mode, if an unknown executable file is monitored, then the unknown executable file is intercepted and the danger prompt information is sent to the terminal. The user will not be allowed to visit the unknown website, unless a message of trusting the unknown website sent by the user via the terminal is detected.

To this end, in the embodiment, a list of blacklists and a list of white-lists of executable files are preset. Suppose that the online shopping monitoring mode or the payment monitoring mode is opened, and a detected executable file is in the list of blacklists, then the running of the executable file is forbidden directly. Or, if the detected executable file is in the list of white-lists, then the executable file is run. Or, if the detected executable file is neither in the list of white-lists, nor in the list of blacklists, that is, the detected executable file is an unknown executable file, then the unknown executable file is intercepted, and the danger prompt information is displayed via the terminal browser. For example, the user is prompted that the unknown executable file may be a dangerous executable file, and the user himself is let to choose whether to trust the unknown executable file. Suppose that the user trusts the unknown executable file (e.g., conducts a trust selection via a trust option in the danger prompt information shown by the terminal browser), and then the previously intercepted executable file is allowed to be run.

In the embodiment of the invention, a monitoring mode is triggered when it is monitored that a user operates a website via a terminal browser; and danger prompt information is sent to the terminal if it is determined that the website which is visited currently by the terminal is unknown, and it is determined that the currently visited website is dangerous according to a preset security policy. According to the embodiment of the invention, it can be achieved that when it is detected that the website visited by the user via the terminal browser is an unknown website, a monitoring server determines whether the currently visited website is dangerous according to a preset security policy, and when it is determined to be dangerous, sends the danger prompt information to the terminal, which reduces the probability of missed detection. Therefore, according to the embodiment of the invention, the security of the online shopping environment of the user can be ensured.

Based on the method for detecting the security of an online shopping environment provided by the embodiment as shown in FIG. 1, suppose that after the user visits a shopping website or payment website via the terminal browser, an interception is not done effectively or a danger prompt is not provided utilizing the method for detecting the security of an online shopping environment provided by the embodiment, and the user is deceived by an illegal website, the user can click an online shopping pre-compensation control to trigger a compensation request via the terminal browser. FIG. 2 is a flow diagram of online shopping pre-compensation provided by another embodiment of the invention. As shown in FIG. 2, the online shopping pre-compensation of the embodiment comprises at least step 105 to step 108.

At 105, a compensation request triggered by the user via the terminal browser is received, wherein the compensation request comprises the identification of an illegal website.

Suppose that after the user visits a shopping website or payment website via the terminal browser, an interception is not done effectively or a danger prompt is not provided utilizing the method for detecting the security of an online shopping environment provided by the embodiment, and the user is deceived by an illegal website, the user can click an online shopping pre-compensation control to trigger a compensation request via the terminal browser. In the embodiment, it is possible to further pop up a window to show a preset compensation rule and an application menu according to the triggered compensation request, and the user fills in the identification (e.g., the URL) of an illegal website in the application menu via the terminal.

At 106, the monitoring log saved in the terminal is queried according to the identification of the illegal website comprised in the compensation request.

When the user opens the online shopping monitoring mode or the payment monitoring mode via the terminal browser, the monitoring log records that the user operates a webpage on a shopping website or a payment website, wherein the operation record comprises, but is not limited to, the identification and the operation time of a website operated by the user via the terminal browser. Therein, the identification of the website comprises, but is not limited to, the domain name or URL of the website, and the operation time comprises the login time and the payment time. Further, information of an item bought by the user on the website can also be saved into the operation record.

By utilizing the method for detecting the security of an online shopping environment provided by the embodiment, the danger prompt information is sent to the terminal when it is monitored that the website is an unknown website and it is determined that the unknown website is a dangerous website according to a preset security policy. The monitoring record can save the identification and a corresponding unknown tag of the website and the danger prompt information into the monitoring log, wherein the identification of the website comprises the domain name or URL of the website.

At 107, it is determined that the interception fails and a message that the compensation request is successful is sent to the terminal if it is determined that the monitoring log comprises the identification of the illegal website and does not comprise the danger prompt information corresponding to the identification of the illegal website.

For example, if after the monitoring log is queried, it is determined that the monitoring log records the operation record of the user logging in the illegal website, but the danger information prompt is not provided for the illegal website, such that the user is deceived by the illegal website, this indicates that the monitoring fails, and a message that the compensation request is successful is sent to the terminal, that is, the compensation request from the user takes effect.

At 108, the identification of the illegal website is added into a website blacklist library.

It needs to be noted that in the embodiment, it is further necessary to add the identification of the illegal website into a website blacklist library.

In a practical application, the monitoring log of the embodiment can further store and display the operation record of the online shopping behaviors of the user to facilitate the user to check, wherein the operation record of the online shopping behaviors comprises the number of times that the user has ever conducted online shopping, the information and time of each shopping website, and the number of claim settlements.

In the embodiment, if after the user visits a shopping website or payment website via the terminal browser, an interception is not done effectively or a danger prompt is not provided utilizing the method for detecting the security of an online shopping environment provided by the embodiment, and the user is deceived by an illegal website, the user can click an online shopping pre-compensation control to trigger a compensation request via the terminal browser, which further ensures the security of the online shopping environment of the user by the online shopping pre-compensation method.

FIG. 4 is a structural diagram of an apparatus for detecting the security of an online shopping environment provided by an embodiment of the invention. In the apparatus for detecting the security of an online shopping environment are run instructions for implementing the method for detecting the security of an online shopping environment. As shown in FIG. 4, the apparatus for detecting the security of an online shopping environment comprises:

a monitoring module 41 configured to trigger a corresponding monitoring mode according to that a user operates a website via a terminal browser, wherein the monitoring mode comprises an online shopping monitoring mode or a payment monitoring mode;

a determination module 42 configured to, in the monitoring mode, determine whether the website is an unknown website and determine whether the unknown website is a dangerous website according to a preset security policy; and

a sending module 43 configured to send danger prompt information to the terminal when the determination module 42 determines that the website is an unknown website and determines that the unknown website is a dangerous website according to the preset security policy, wherein the security policy is a preset policy for guaranteeing security of an online shopping environment.

Optionally, the determination module 42 is particularly configured to

determine that the unknown website is a dangerous website if it is determined according to q domain name of the unknown website that the domain name is a second level domain name and the second level domain name is comprised in a domain name blacklist; and/or

determine that the unknown website is a dangerous website according to an IP address of the unknown website if the IP address is comprised in an IP address blacklist; and/or

according to an uniform resource locator URL of the unknown website, calculate a hash value of the URL, and determine that the unknown website is a dangerous website if the calculated hash value is comprised in a hash value blacklist; and/or

according to a monitoring log saved in the terminal, and numbers of white-list tags, blacklist tags and unknown tags of websites operated by the terminal recorded in a preset period of time, determine that the unknown website is a dangerous website if the number of the blacklist tags is greater than a preset threshold; or determine that the unknown website is a dangerous website if the number of the unknown tags is greater than a preset threshold and the number of the white-list tags is less than or equal to the number of the blacklist tags.

Optionally, the monitoring module 41 is particularly configured to

obtain a keyword comprised in the domain name of the website, and determine that the website is a shopping website and open the online shopping monitoring mode if the keyword matches a preset online shopping feature word; or determine that the website is a payment website and open the payment monitoring mode if the keyword matches a preset payment feature word.

Optionally, the apparatus for detecting the security of an online shopping environment further comprises:

a saving module 44 configured to save the operation record of a user operating a website via a terminal browser in the monitoring log, wherein the operation record comprises the identification and the operation time of the website.

Optionally, the saving module 44 is further configured to save the identification and a corresponding unknown tag of the website and the danger prompt information in the monitoring log, wherein the identification of the website comprises the domain name or URL of the website.

Optionally, the apparatus for detecting the security of an online shopping environment further comprises:

a reception module 45 configured to receive a compensation request triggered by the user via the terminal browser, wherein the compensation request comprises the identification of an illegal website;

a query module 46 configured to query the monitoring log saved by the saving module 44 according to the identification of the illegal website comprised in the compensation request received by the reception module 45;

wherein the determination module 42 is further configured to determine that the interception fails if it is determined that the monitoring log comprises the identification of the illegal website and does not comprise danger prompt information corresponding to the identification of the illegal website;

the sending module 43 is further configured to send to the terminal a message that the compensation request is successful when the determination module determines that the interception fails; and

the saving module 44 is further configured to add the identification of the illegal website into a website blacklist library.

In the embodiment of the invention, a monitoring mode is triggered when it is monitored that a user operates a website via a terminal browser; and danger prompt information is sent to the terminal if it is determined that the website which is visited currently by the terminal is unknown, and it is determined that the currently visited website is dangerous according to a preset security policy. According to the embodiment of the invention, it can be achieved that when it is detected that the website visited by the user via the terminal browser is an unknown website, a monitoring server determines whether the currently visited website is dangerous according to a preset security policy, and when it is determined to be dangerous, sends the danger prompt information to the terminal, which reduces the probability of missed detection. Therefore, according to the embodiment of the invention, the security of the online shopping environment of the user can be ensured.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a client for detecting the security of an online shopping environment according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

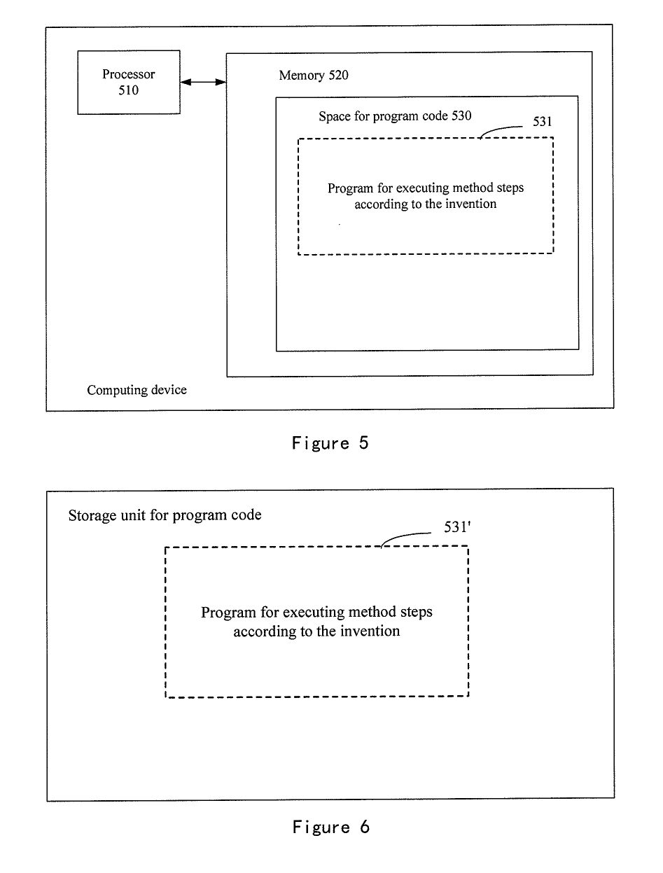

For example, FIG. 5 shows a computing device which may carry out a method for detecting the security of an online shopping environment according to the invention. The computing device traditionally comprises a processor 510 and a computer program product or a computer readable medium in the form of a memory 520. The memory 520 may be an electronic memory such as a flash memory, an EEPROM (electrically erasable programmable read-only memory), an EPROM, a hard disk or a ROM. The memory 520 has a memory space 530 for a program code 531 for carrying out any method steps in the methods as described above. For example, the memory space 530 for a program code may comprise individual program codes 531 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 6. The storage unit may have a memory segment, a memory space, etc. arranged similarly to the memory 520 in the computing device of FIG. 5. The program code may for example be compressed in an appropriate form. In general, the storage unit comprises a computer readable code 531′, i.e., a code which may be read by e.g., a processor such as 510, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A method for detecting security of an online shopping environment, characterized by comprising:
triggering a corresponding monitoring mode according to that a user operates a website via a terminal browser, wherein the monitoring mode comprises an online shopping monitoring mode or a payment monitoring mode;
sending danger prompt information to the terminal if in the monitoring mode it is monitored that the website is an unknown website and it is determined that the unknown website is a dangerous website according to a preset security policy, wherein the security policy is a preset policy for guaranteeing security of an online shopping environment;
wherein determining that the unknown website is a dangerous website according to a preset security policy comprises at least one of the following:
determining that the unknown website is a dangerous website if it is determined according to a domain name of the unknown website that the domain name is a second level domain name and the second level domain name is comprised in a domain name blacklist;
determining that the unknown website is a dangerous website according to an IP address of the unknown website if the IP address is comprised in an IP address blacklist;
according to an uniform resource locator URL of the unknown website, calculating a hash value of the URL, and determining that the unknown website is a dangerous website if the calculated hash value is comprised in a hash value blacklist; and
according to a monitoring log saved in the terminal, and numbers of white-list tags, blacklist tags and unknown tags of websites operated by the terminal recorded in a preset period of time, determining that the unknown website is a dangerous website if the number of the blacklist tags is greater than a preset threshold; or determining that the unknown website is a dangerous website if the number of the unknown tags is greater than a preset threshold and the number of the white-list tags is less than or equal to the number of the blacklist tags.

2. The method as claimed in claim 1, characterized in that, the triggering a corresponding monitoring mode according to that a user operates a website via a terminal browser comprises:
obtaining a keyword comprised in the domain name of the website, and determining that the website is a shopping website and opening the online shopping monitoring mode if the keyword matches a preset online shopping feature word; or determining that the website is a payment website and opening the payment monitoring mode if the keyword matches a preset payment feature word.

3. The method as claimed in claim 1, characterized in that, after the triggering a corresponding monitoring mode according to that a user operates a website via a terminal browser, there is comprised:
saving an operation record of the user operating the website via the terminal browser in the monitoring log, wherein the operation record comprises an identification and operation time of the website.

4. The method as claimed in claim 1, characterized in that, after the sending danger prompt information to the terminal in the monitoring mode if it is monitored that the website is an unknown website and it is determined that the unknown website is a dangerous website according to a preset security policy, there is comprised:
saving an identification and a corresponding unknown tag of the website and the danger prompt information in the monitoring log, wherein the identification of the website comprises a domain name or URL of the website.

5. The method as claimed in claim 4, characterized by further comprising:
receiving a compensation request triggered by the user via the terminal browser, wherein the compensation request comprises the identification of an illegal website;
querying the monitoring log saved in the terminal according to the identification of the illegal website comprised in the compensation request;
determining that the interception fails and sending to the terminal a message that the compensation request is successful, if it is determined that the monitoring log comprises the identification of the illegal website and does not comprise the danger prompt information corresponding to the identification of the illegal website; and
adding the identification of the illegal website into a website blacklist library.

6. The method as claimed in claim 1, characterized in that, after the triggering a corresponding monitoring mode according to that a user operates a website via a terminal browser, there is further comprised:
if an unknown executable file is monitored in the monitoring mode, intercepting the unknown executable file and sending danger prompt information to the terminal.

7. An apparatus for detecting security of an online shopping environment, characterized by comprising:
a memory having instructions stored thereon;
a processor configured to execute the instructions to perform following operations:
triggering a corresponding monitoring mode according to that a user operates a website via a terminal browser, wherein the monitoring mode comprises an online shopping monitoring mode or a payment monitoring mode;
in the monitoring mode determining whether the website is an unknown website and determining whether the unknown website is a dangerous website according to a preset security policy;
sending danger prompt information to the terminal when it is determined that the website is an unknown website and determines that the unknown website is a dangerous website according to the preset security policy, wherein the security policy is a preset policy for guaranteeing security of an online shopping environment;
wherein determining that the unknown website is a dangerous website is a dangerous website according to a preset security policy comprises at least one of the following:
determining that the unknown website is a dangerous website if it is determined according to a domain name of the unknown website that the domain name is a second level domain name and the second level domain name is comprised in a domain name blacklist; and/or
determining that the unknown website is a dangerous website according to an IP address of the unknown website if the IP address is comprised in an IP address blacklist; and/or
according to an uniform resource locator URL of the unknown website, calculating a hash value of the URL, and determining that the unknown website is a dangerous website if the calculated hash value is comprised in a hash value blacklist; and/or
according to a monitoring log saved in the terminal, and numbers of white-list tags, blacklist tags and unknown tags of websites operated by the terminal recorded in a preset period of time, determining that the unknown website is a dangerous website if the number of the blacklist tags is greater than a preset threshold; or determining that the unknown website is a dangerous website if the number of the unknown tags is greater than a preset threshold and the number of the white-list tags is less than or equal to the number of the blacklist tags.

8. The apparatus as claimed in claim 7, characterized in that, the triggering a corresponding monitoring mode according to that a user operates a website via a terminal browser comprises:
obtaining a keyword comprised in the domain name of the website, and determining that the website is a shopping website and opening the online shopping monitoring mode if the keyword matches a preset online shopping feature word; or determining that the website is a payment website and opening the payment monitoring mode if the keyword matches a preset payment feature word.

9. The apparatus as claimed in claim 7, characterized in that, after the triggering a corresponding monitoring mode according to that a user operates a website via a terminal browser, the operations further comprise:
saving an operation record of a user operating a website via a terminal browser in the monitoring log, wherein the operation record comprises an identification and operation time of the website.

10. The apparatus as claimed in claim 7, characterized in that, after the sending danger prompt information to the terminal in the monitoring mode if it is monitored that the website is an unknown website and it is determined that the unknown website is a dangerous website according to a preset security policy, the operations further comprise:
saving an identification and a corresponding unknown tag of the website and the danger prompt information in the monitoring log, wherein the identification of the website comprises a domain name or URL of the website.

11. The apparatus as claimed in claim 10, characterized in that, the operations further comprise:
receiving a compensation request triggered by the user via the terminal browser, wherein the compensation request comprises the identification of an illegal website;
querying the monitoring log saved by the saving module according to the identification of the illegal website comprised in the compensation request received by the reception module;
determining that the interception fails when it is determined that the monitoring log comprises the identification of the illegal website and does not comprise the danger prompt information corresponding to the identification of the illegal website;
sending to the terminal a message that the compensation request is successful when it is determined that the interception fails; and
adding the identification of the illegal website into a website blacklist library.

12. (canceled)

13. A non-transitory computer readable medium having instructions stored thereon that, when executed by at least one processor, cause the at least one processor to perform following operations:
triggering a corresponding monitoring mode according to that a user operates a website via a terminal browser, wherein the monitoring mode comprises an online shopping monitoring mode or a payment monitoring mode;
sending danger prompt information to the terminal if in the monitoring mode it is monitored that the website is an unknown website and it is determined that the unknown website is a dangerous website according to a preset security policy, wherein the security policy is a preset policy for guaranteeing security of an online shopping environment;
wherein determining that the unknown website is a dangerous website according to a preset security policy comprises at least one of the following:
determining that the unknown website is a dangerous website if it is determined according to a domain name of the unknown website that the domain name is a second level domain name and the second level domain name is comprised in a domain name blacklist;
determining that the unknown website is a dangerous website according to an IP address of the unknown website if the IP address is comprised in an IP address blacklist;
according to an uniform resource locator URL of the unknown website, calculating a hash value of the URL, and determining that the unknown website is a dangerous website if the calculated hash value is comprised in a hash value blacklist; and
according to a monitoring log saved in the terminal, and numbers of white-list tags, blacklist tags and unknown tags of websites operated by the terminal recorded in a preset period of time, determining that the unknown website is a dangerous website if the number of the blacklist tags is greater than a preset threshold; or determining that the unknown website is a dangerous website if the number of the unknown tags is greater than a preset threshold and the number of the white-list tags is less than or equal to the number of the blacklist tags.
